(19) United States
(12) Patent Application Publication
(10) Pub. No.: US 2009/0031215 A1
(43) Pub. Date: Jan. 29, 2009

(54) METHOD AND APPARATUS FOR GENERATING AN ELECTRONIC LEARNING PRESENTATION IN A NETWORK COMPUTING ENVIRONMENT

(76) Inventors: James Patrick Collier, II, San Antonio, TX (US); Michael William Whirlow, San Antonio, TX (US)

Correspondence Address: DUKE W. YEE, YEE AND ASSOCIATES, P.C., P.O. BOX 802333, DALLAS, TX, 75380, US

(21) Appl. No.: 11/781,367

(22) Filed: Jul. 23, 2007

(51) Int. Cl. G06F 15/00; G06F 17/28; G06F 17/27

(52) U.S. Cl. 715/255

(57) ABSTRACT

The illustrative embodiments described herein provide a computer-implemented method, apparatus, and computer program product for generating an electronic learning presentation in a network-computing environment. In one embodiment, the process presents a list of templates. Each template in the list of templates includes a set of editable fields adapted for receiving educational content. The educational content is adapted for teaching a particular subject matter. The process receives a selection of at least one template in the list of templates. The process also receives the educational content into the at least one template. The process generates a set of pages using the at least one template to form the electronic learning presentation. The set of pages includes the educational content.

### BACKGROUND OF THE INVENTION

1. Field of the Invention

The present invention relates generally to a data processing system and in particular to a method and apparatus for generating a presentation. More particularly, the present invention is directed to a computer-implemented method, apparatus, and computer-usable program code for generating an electronic learning presentation in a network-computing environment.

2. Description of the Related Art

Electronic learning generally refers to the computer-enhanced learning of a particular subject matter. The worldwide electronic learning industry is estimated to be worth billions of dollars. Three important sectors of the electronic learning industry include educational content, technologies, and services. Electronic learning may be used by a variety of organizations and entities, such as an education institution, a corporation, or any branch of government.

The evolution of electronic learning has advanced with the development of Internet and multimedia technologies. Among the first general-purpose systems for computer-assisted instruction from which electronic learning evolved was the PLATO System developed at The University of Illinois at Urbana-Champaign. By the mid-1980's, several institutions of online learning had appeared, including the Western Behavioural Sciences Institute, the New York Institute of Technology, and the Electronic Information Exchange System.

According to the Sloan Consortium, an authoritative source of information about online higher education, more than 1.9 million students were participating in online learning at institutions of higher education in the United States by 2003. Online learning has a rate of growth of about 25 percent per year. According to the Sloan Consortium, virtually all public higher education institutions, as well as a vast majority of private, for-profit institutions, now offer online classes.

Electronic learning utilizes a wide spectrum of technologies. Non-limiting examples of technologies that may be used in electronic learning include screencasts, ePortfolios, electronic performance support systems, palm pilots, hypermedia, the Internet, discussion boards, collaborative software, electronic mail, blogs, computer aided assessments, education animation, simulations, games, and electronic voting systems.

Learning management systems are one of several avenues currently used for the distribution of online educational content to users. A learning management system is a software package that enables the management and delivery of online content to users. A learning management system allows for user registration, delivery of learning and educational activities, and a user assessment in an online environment. More comprehensive learning management systems often include tools such as competency management, skills-gap analysis, succession planning, certifications, and resource allocation.

Electronic learning presentations are often made up of learning objects. Learning objects can be useful for creating and re-using educational content in electronic learning presentations. Learning objects are self-contained units that are tagged with keywords, or other metadata. Learning objects may be stored in an extensible markup language (XML) file format. Creating an electronic learning presentation often requires putting together a sequence of learning objects. A common standard format for education content in electronic learning presentations is Sharable Content Object Reference Model (SCORM). SCORM is a specification of the Advanced Distributive Learning Initiative, which is a project of the United States Secretary of Defense. The Advanced Distributive Learning Initiative was originally tasked with leading a collaborative effort to use information technologies to modernize structured learning. Today, the Advanced Distributive Learning Initiative employs a structured, adaptive, and collaborative effort between the public and private sectors to develop standards, tools, and learning content for modern learning environments.

One hindrance to the proliferation of electronic learning is the cost and time associated with creating electronic learning presentations. For example, developing military web-based training for the United States Air Force has proven a costly and time-consuming process. Subject matter experts provide education content to web-based training developers, who traditionally have a technical background and have training in multimedia areas. Web-based training developers may be external consultants or part of a larger internal or external organization.

However, hiring web-based training developers can be costly. The cost to develop a single hour of web-based training can be as high as $300,000. On the other hand, internally developing a web-based training module without the aid of web-based training developers can take as long as one year to eighteen months. In addition, even if web-based training developers are used to develop a web-based training module, organization may not have the means to modify the module to adapt to developments in the subject matter taught by the module.

Furthermore, many current methods for the development of web-based training fail to generate electronic learning presentations that conform to SCORM standards or Advanced Distributed Learning Initiative standards. Hence, these electronic learning presentations may not be compatible with learning management systems that use SCORM.

### SUMMARY OF THE INVENTION

The illustrative embodiments described herein provide a computer-implemented method, apparatus, and computer program product for generating an electronic learning presentation in a network-computing environment. In one embodiment, the process presents a list of templates. Each template in the list of templates includes a set of editable fields adapted for receiving educational content. The educational content is adapted for teaching a particular subject matter. The process receives a selection of at least one template in the list of templates. The process also receives the educational content into the at least one template. The process generates a set of pages using the at least one template to form the electronic learning presentation. The set of pages includes the educational content.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which the illustrative embodiments may be implemented;

FIG. 2 is a block diagram of a data processing system in which the illustrative embodiments may be implemented;

FIG. 3 is a block diagram of a system for generating an electronic learning presentation in a network-computing environment in accordance with an illustrative embodiment;

FIG. 4 is a graphical representation of a course creator in a system for generating an electronic learning presentation in a network-computing environment in accordance with an illustrative embodiment;

FIG. 5 is a graphical representation of a page editor in a system for generating an electronic learning presentation in a network-computing environment in accordance with an illustrative embodiment;

FIG. 6 is a graphical representation of a page editor in a system for generating an electronic learning presentation in a network-computing environment in accordance with an illustrative embodiment;

FIG. 7 is a graphical representation of a content page template in a system for generating an electronic learning presentation in a network-computing environment in accordance with an illustrative embodiment;

FIG. 8 is a graphical representation of a content page with audio template in a system for generating an electronic learning presentation in a network-computing environment in accordance with an illustrative embodiment;

FIG. 9 is a graphical representation of an assessment question template in a system for generating an electronic learning presentation in a network-computing environment in accordance with an illustrative embodiment;

FIG. 10 is a graphical representation of a progress check template in a system for generating an electronic learning presentation in a network-computing environment in accordance with an illustrative embodiment;

FIG. 11 is a graphical representation of a page editor in a system for generating an electronic learning presentation in a network-computing environment in accordance with an illustrative embodiment;

FIG. 12 is a graphical representation of a content page in an electronic learning presentation in a system for generating an electronic learning presentation in a network-computing environment in accordance with an illustrative embodiment;

FIG. 13 is a graphical representation of a content page with audio in an electronic learning presentation in a system for generating an electronic learning presentation in a network-computing environment in accordance with an illustrative embodiment;

FIG. 14 is a graphical representation of an assessment question page in an electronic learning presentation in a system for generating an electronic learning presentation in a network-computing environment in accordance with an illustrative embodiment;

FIG. 15 is a graphical representation of a progress check page in an electronic learning presentation in a system for generating an electronic learning presentation in a network-computing environment in accordance with an illustrative embodiment;

FIG. 16 is a graphical representation of a content navigator in a system for generating an electronic learning presentation in a network-computing environment in accordance with an illustrative embodiment;

FIG. 17 is a graphical representation of a preview launcher in a system for generating an electronic learning presentation in a network-computing environment in accordance with an illustrative embodiment;

FIG. 18 is a graphical representation of an application settings module in a system for generating an electronic learning presentation in a network-computing environment in accordance with an illustrative embodiment; and

FIG. 19 is a flowchart illustrating a process for generating an electronic learning presentation in a network-computing environment in accordance with an illustrative embodiment.

### DETAILED DESCRIPTION OF THE PREFERRED EMBODIMENT

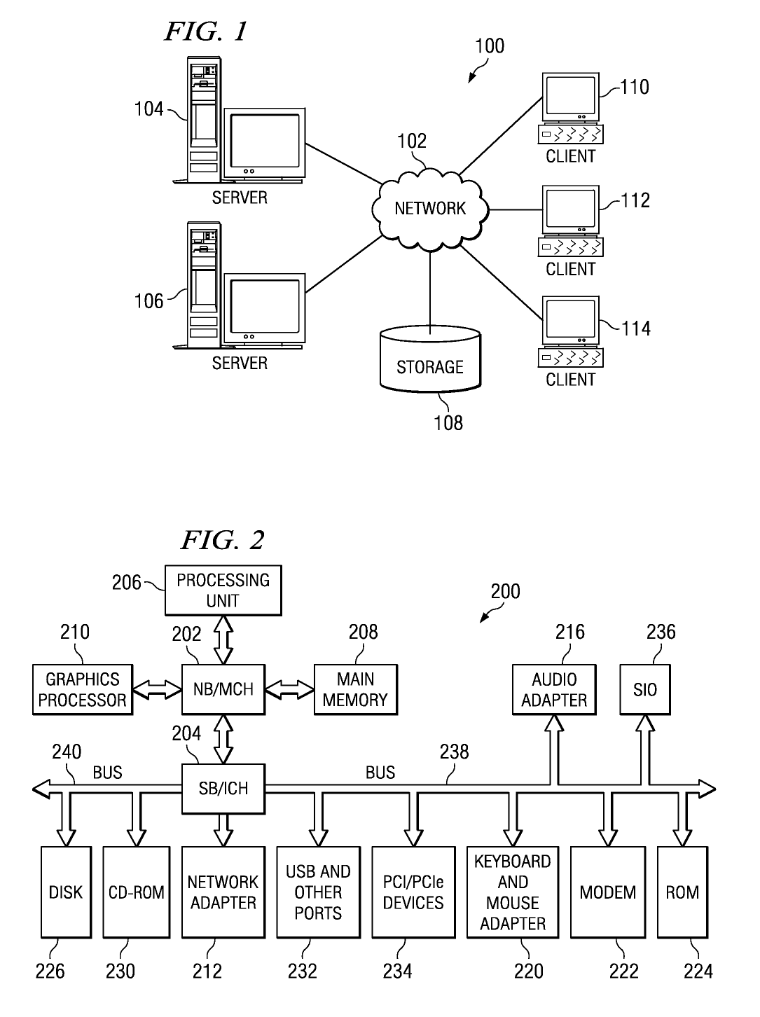

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. In one example, electronic learning presentations are transmitted over network 102. Network 102 may include connections, such as wire, wireless communication links, or fiber optic cables.

In the depicted example, server 104 and server 106 connect to network 102 along with storage unit 108. In one example, storage 108 stores data associated with a learning management system or one or more electronic learning presentations. In addition, clients 110, 112, and 114 connect to network 102. Clients 110, 112, and 114 may be, for example, personal computers or network computers.

In the depicted example, server 104 provides data, such as boot files, operating system images, and applications to clients 110, 112, and 114. In one example, server 104 hosts a learning management system for the distribution of electronic learning presentations. Clients 110, 112, and 114 are clients to server 104 in this example. In one example, clients 110, 112, and 114 display an electronic learning presentation to a user. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer-implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer-implemented method, apparatus, and computer program product for generating an electronic learning presentation in a network-computing environment. In one embodiment, the process presents a list of templates. A list of templates includes one or more templates. Each template in the list of templates includes a set of editable fields adapted for receiving educational content. The set of editable fields includes one or more editable fields. An editable field is a field that is capable of receiving input from a source.

Educational content is content that is adapted for teaching a particular subject matter. A particular subject matter is any subject matter that is capable of being taught. Non-limiting examples of a subject matter include subjects taught at educational institutions, such as physics, sociology, and mathematics. A subject matter also includes work or vocation-related topics, as well as topics that relate to the administration of an organization, such as personnel topics.

The process receives a selection of at least one template in the list of templates. The process also receives the educational content into the at least one template. The process generates a set of pages using the at least one template to form the electronic learning presentation. The set of pages includes the educational content, and includes one or more pages. In one example, the set of pages is a set of hypertext markup language pages.

The electronic learning presentation may also be adapted to be included in a learning management system. A learning management system is a software package that enables the management and delivery of online content to users.

In one embodiment, the process sequences the set of pages into an order in response to input indicating the order. In this embodiment, the input may be from a user or another application. In another embodiment, the process provides a preview of the electronic learning presentation to a user interface.

In another embodiment, the process provides a capability for an outside application to modify the electronic learning presentation such that the electronic learning presentation is compatible with a learning management system. In this example, the learning management system may be compatible with Sharable Content Object Reference Model standards. Also, the outside application may be any computer application capable of modifying an electronic learning presentation to be compatible with a learning management system that is compatible with Sharable Content Object Reference Model standards. Sharable Content Object Reference Model standards may include the standards of any version of the Sharable Content Object Reference Model, such as version 1.2 protocols.

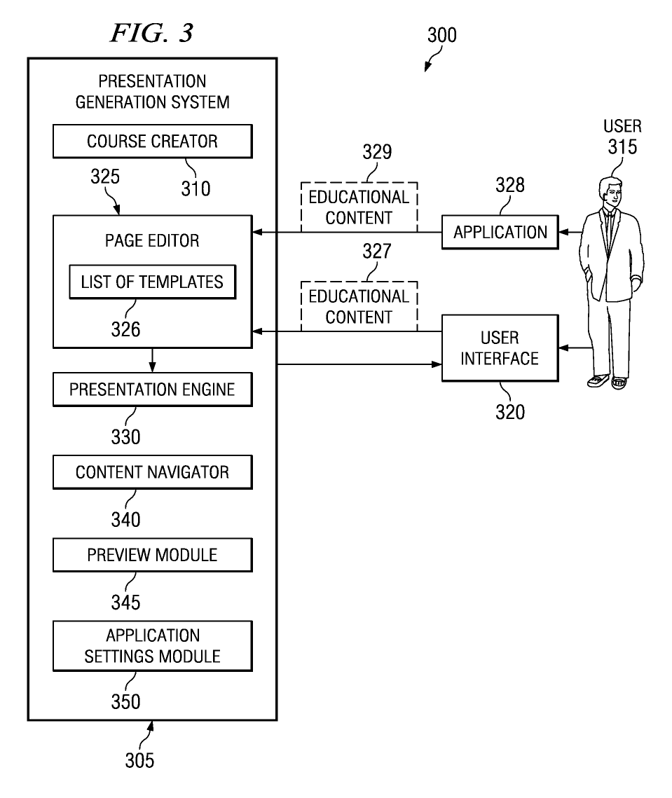

Turning now to FIG. 3, a block diagram of a system for generating an electronic learning presentation in a network-computing environment is depicted in accordance with an illustrative embodiment. Specifically, FIG. 3 shows presentation generation system 305 in data processing system 300. Data processing system 300 may be included in another data processing system, such as network data processing system 100, clients 110, 112, and 114, and servers 104 and 106 in FIG. 1. Data processing system 300 may also be included in data processing system 200 in FIG. 2.

Presentation generation system 305 is software, hardware, or a combination thereof that generates an electronic learning presentation in a network computing environment. Generating an electronic learning presentation includes either or both of creating or modifying an electronic learning presentation. Presentation generation system 305 may be implemented on any development platform. In one non-limiting example, presentation generation system 305 is implemented using Java version J2SE 5.0 and deployed using a standard installation package. Java™ is a product of Sun Microsystems Corporation®.

Presentation generation system 305 includes course creator 310. Course creator 310 allows user 315 to make initial selections regarding an electronic learning presentation prior to creating the set of pages in the electronic learning presentation.

User 315 may be any person capable of utilizing user interface 320 to interact with presentation generation system 305. For example, user 315 may be a developer, an employee at a corporation, or a teacher at an educational institution. Although FIG. 3 shows a single user 315, any number of users may have access or interact with presentation generation system 305. For example, multiple users may have access to presentation generation system 305 through a network, such as network 102 in FIG. 1.

User interface 320 may be any device able to provide an electronic learning presentation to a user. Additionally, user interface 320 may allow user 315 to interact with presentation generation system 305. Although user interface 320 is shown as part of data processing system 300, user interface 320 may also be a device that is separate from data processing system 300 or connected to data processing system 300 over a network. For example, user interface 320 may be a data processing system, such as servers 104 and 106 in FIG. 1, clients 110, 112, and 114 in FIG. 1, a personal digital assistant, a laptop computer, a cellular phone, a kiosk, a voice-recognition interface system, a touch screen, or any other interface that allows user 315 to interact with presentation generation system 305. User interface 320 may also work in conjunction with software interfaces, such as web browsers or any application associated with presentation generation system 305.

Course creator 310 allows user 315 to select a course template to be applied to the electronic learning presentation. Non-limiting examples of course templates from which user 315 may make a selection include a web-based training template, a standard template, and an independent template. The standard template and the independent template are both information and learning technologies templates. The standard template shares a “common” Sharable Content Object Reference Model asset. The independent template does not share from a “common” Sharable Content Object Reference Model asset, and instead encapsulates those “common” assets within the sharable content object.

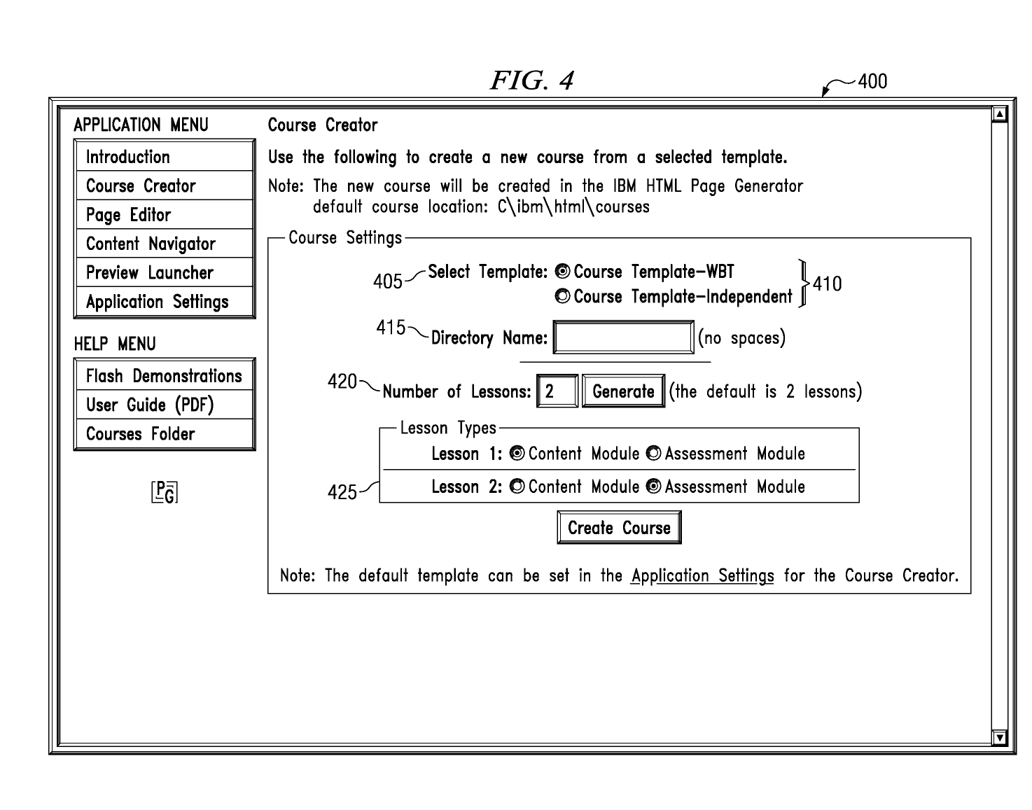

In another example, course creator 310 contains an editable field for specifying a directory for storing files and file folders associated with the electronic learning presentation. In one non-limiting example, files and file folders associated with the electronic learning presentation may be stored in the “c:\ibm\html\courses\” folder. The “c:\ibm\html\courses\” folder may also be a default folder for storing files and file folders associated with the electronic learning presentation in the event that no other folder is specified. Further details regarding course creator 310 will be provided with respect to FIG. 4.

Presentation generation system 305 includes page editor 325. Page editor 325 provides user 315 with the capability to create or modify a set of pages in an electronic learning presentation. In one embodiment, the set of pages is a set of hypertext markup language pages. Page editor 325 presents list of templates 326 on user interface 320 and receives a selection of at least one template in list of templates 326. The selection may be made by user 315.

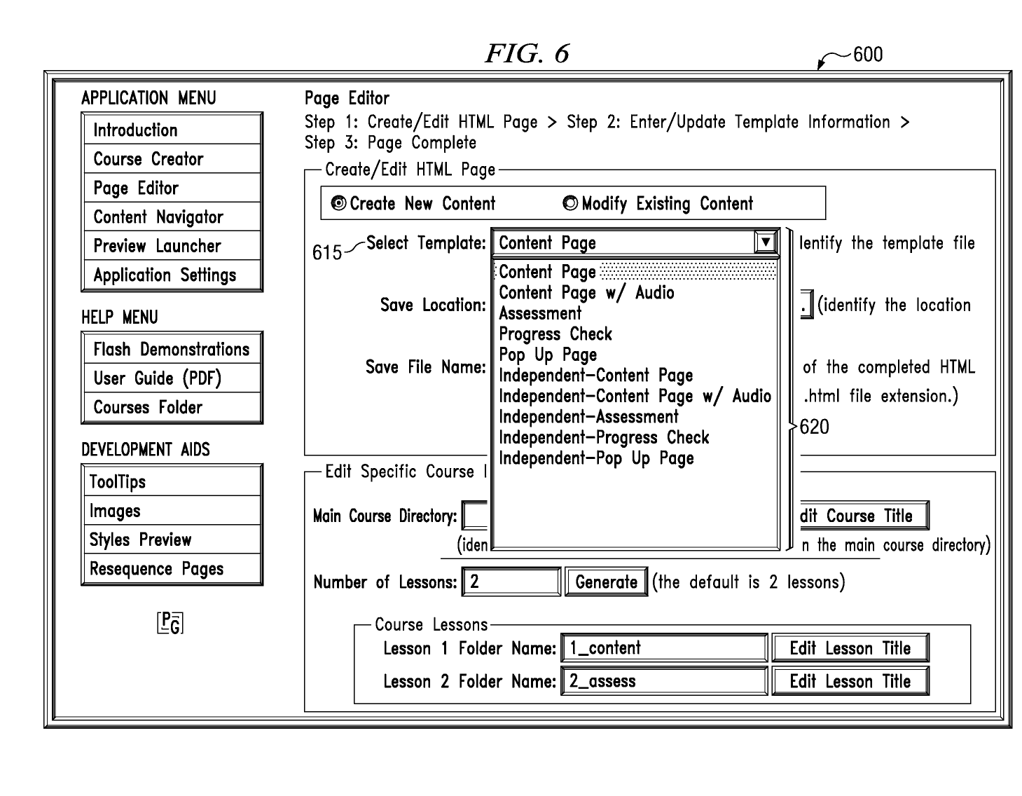

Page editor 325 receives educational content into one or more templates selected by user 315. For example, educational content may be educational content 327, which is received by one or more templates via user interface 320. Each template in list of templates 326 includes a set of editable fields adapted for receiving educational content in a particular subject matter. The set of editable fields includes one or more editable fields. Non-limiting examples of an editable field include a simple text field, a long text field with rich-text editor controls, radio buttons, check boxes, drop-down list boxes, and multi-select input boxes. Educational content may be inputted or edited in the set of editable fields by user 315 in a rich text environment, similar to the environment created by a word processor such as Microsoft Word®, which is a product of Microsoft® Corporation. Details relating to the templates that are available in page editor 325 will be discussed in greater detail with respect to FIGS. 6-10.

In one embodiment, educational content 329 may be transferred to one or more editable fields in a template from application 328. In one example, user 315 may transfer educational content 329 from application 328 to page editor 325 using a copy-and-paste or cut-and-paste operation. Application 328 may be any application that includes transferable educational content. Non-limiting examples of application 328 include Word, PowerPoint, or Excel, each of which is produced by Microsoft® Corporation. Although FIG. 3 shows a single application 328, educational content 329 may be transferred to page editor 325 from any number of applications. Also, although FIG. 3 shows application 328 as part of data processing system 300, application 328 may be connected to data processing system 300 via a network, such as network 102 in FIG. 1.

Page editor 325 provides user 315 with the option to either create a new set of pages or modify an existing set of pages in an electronic learning presentation. Page editor 325 also allows user 315 to specify a file name for a newly created set of pages and choose a directory location into which the set of pages will be saved.

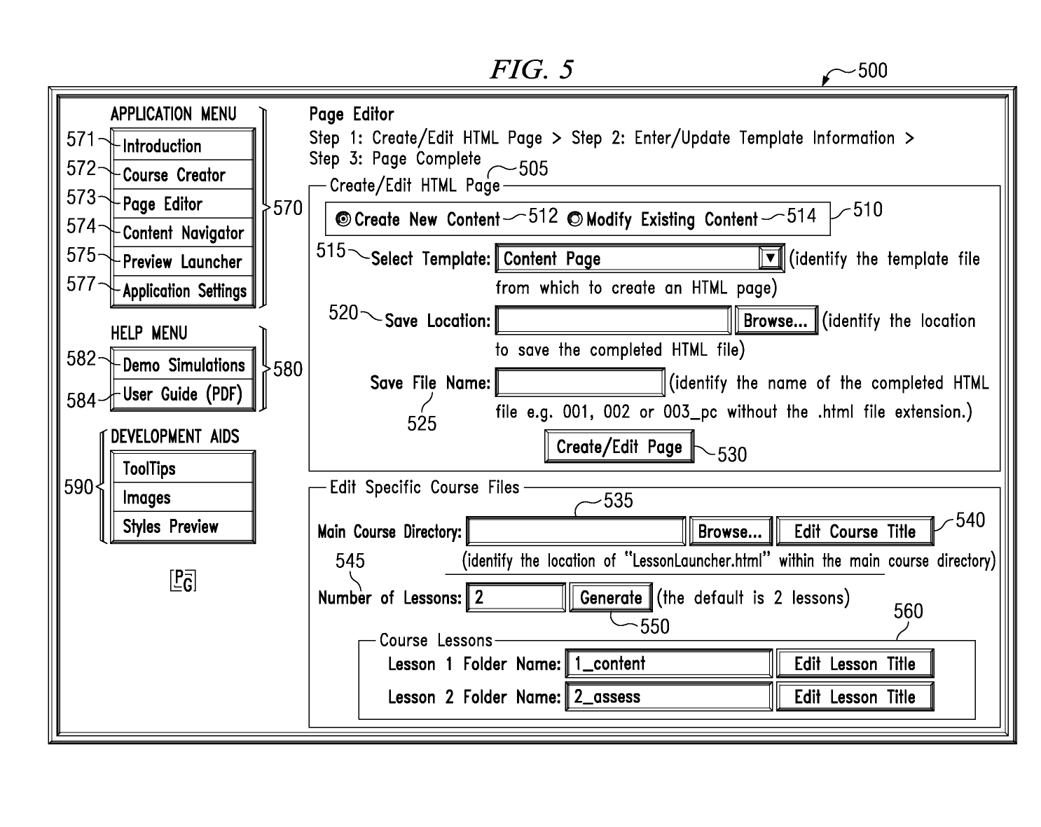

Page editor 325 also allows user 315 to edit a course file that includes the electronic learning presentation. For example, page editor 325 provides the capability to edit the name of a course file. Page editor 325 also provides the capability to change the number of lessons in a course file, as well as change the name of the lessons in a course file. A lesson is any set of pages in the electronic learning presentation that relate to a common topic or goal. For example, a lesson may be a set of pages that assess the knowledge of user 315 on a particular skill that relates to the subject matter of the electronic learning presentation. Additional embodiments of page editor 325 will be provided with respect to FIGS. 5-11.

Page editor 325 may be used to dynamically modify the electronic learning presentation in real-time based on additional input from a set of users. The set of users includes one or more users, and may include user 315. An electronic learning presentation is dynamically modified in real-time if changes made to an electronic learning presentation by one of the set of users are perceivable to other users in the set of users at approximately the same time that the changes are made.

In one example, at least two users in the set of users may dynamically modify an electronic learning presentation over a network, such as network 102 in FIG. 1. In this example, changes made by one of the users over the network are visible to the other user at approximately the same time as the change is made.

Presentation generation system 305 also includes presentation engine 330. Presentation engine 330 generates a set of pages using one or more selected templates to form the electronic learning presentation. The one or more templates used to form the electronic learning presentation may have been selected by user 315, or may have been selected by an automated process associated with application 328.

The set of pages in the generated electronic learning presentation includes the educational content that was received by the one or more templates. In one embodiment, presentation engine 330 interprets hypertext markup language tags associated with the one or more templates to render educational content in a predetermined configuration within the set of pages. In another embodiment, the set of pages generated by presentation engine 330 may be encapsulated into separate files.

Presentation engine 330 may also generate a second set of pages using a different template in list of templates 326. The second set of pages is included in the electronic learning presentation. An electronic learning presentation may include multiple sets of pages, each set using a different template. In one embodiment, each set of pages may be a different lesson in the electronic learning presentation.

The electronic learning presentation that is generated by presentation engine 330 may be adapted to be included in a learning management system. A learning management system is a software package that enables the management and delivery of online content to users. In one example, a learning management system may host one or more electronic learning presentations over the Internet.

Both open source and commercial learning management systems exist in the marketplace. Learning management systems may cater to different educational, administrative, and deployment requirements. Examples of learning management systems include ATutor, .LRN, and Bodington. In one embodiment, an electronic learning presentation generated by presentation engine 330 may be hosted from a learning management system.

The electronic learning presentation may be generated by presentation engine 330 according to Sharable Content Object Reference Model standards. In one embodiment, Sharable Content Object Reference Model standards include the standards of the Sharable Content Object Reference Model, also termed SCORM®, of the Advanced Distributed Learning Initiative, which is associated with the United States Office of the Secretary of Defense. The Sharable Content Object Reference Model is a collection of standards and protocols that use extensible markup language, and that may be used for electronic learning, including electronic learning presentations. The collection of standards and protocols may define the type of communication used for a particular learning management system.

For example, the Sharable Content Object Reference Model may define communications between a client, such as clients 110, 112, and 114 in FIG. 1, and a host system, such as servers 103 and 106 in FIG. 1. The electronic learning presentation may also be generated by presentation engine 330 to conform to any standard used by any learning management system.

In another example, an external application may be used to modify the electronic learning presentation such that the electronic learning presentation is compatible with a particular learning management system. One non-limiting example of such an external application is Reusable Elearning Object Authoring and Delivery (RELOAD), which is a project funded by the Joint Information Systems Committee Exchange for Learning Programme.

In another embodiment, the electronic learning presentation is generated by presentation engine 330 in an online mode. In an online mode, an electronic learning presentation that is generated by presentation engine 330 may be accessed by a user, such as user 315, over a network, such as network 102 in FIG. 1. Online mode allows users in separate locations that are connected by a network to have quick access to electronic learning presentations created or modified by one or more users on the network.

In another embodiment, the electronic learning presentation is generated by presentation engine 330 in an offline mode. In an offline mode, an electronic learning presentation that is generated by presentation engine 330 cannot be accessed over a network, such as network 102 in FIG. 1. However, an electronic learning presentation that is generated in an offline mode may be distributed at any time after being generated. For example, the electronic learning presentation may be distributed over a network, or may be bundled or distributed as part of a software package.

Presentation generation system 305 also includes content navigator 340. Content navigator 340 may sequence the set of pages in an electronic learning presentation into a particular order in response to input indicating the order. Content navigator 340 may also be used to add or delete pages from the set of pages in an electronic learning presentation. In one example, the input indicating the order of the set of pages in an electronic learning presentation is provided by user 315.

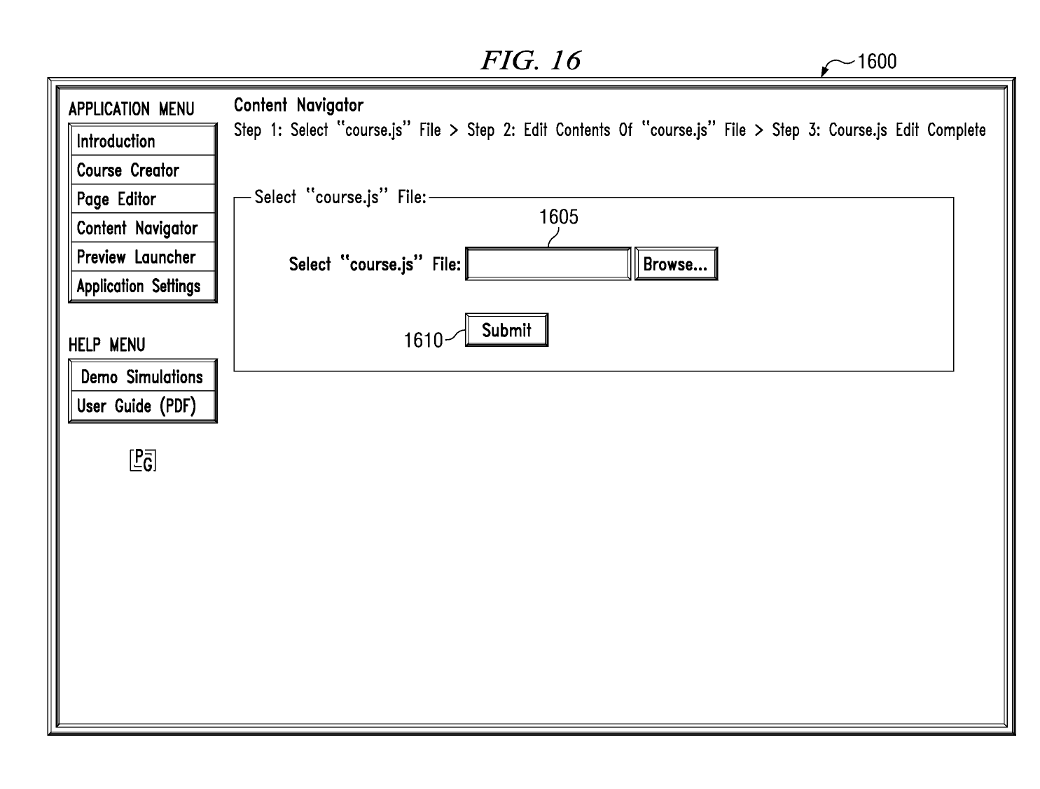

Content navigator may also queue user 315 to provide the name of a script file, such as a course file having an extension “*.js”, associated with the electronic learning presentation so that pages in the set of pages in the electronic learning presentation can be added, deleted, or sequenced into a particular order. Content navigator 340 will be discussed in further detail with respect to FIG. 16 below.

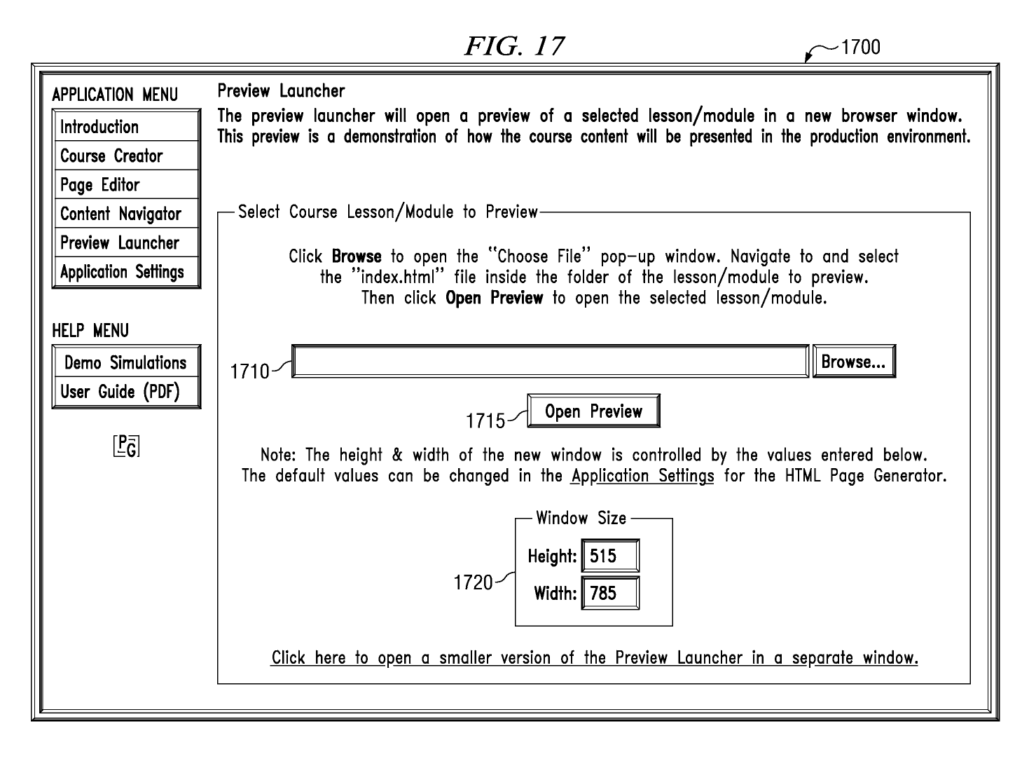

Presentation generation system 305 also includes preview module 345. Preview module 345 provides a preview of the electronic learning presentation to user 315 via user interface 320. In one example, preview module 345 allows user 315 to select a set of pages, an electronic learning presentation, or a course file to preview. In another example, the preview may be displayed in a browser window on user interface 320. The size of the browser window may be customized by user 315. Preview module 345 will be discussed in greater detail with respect to FIG. 17 below.

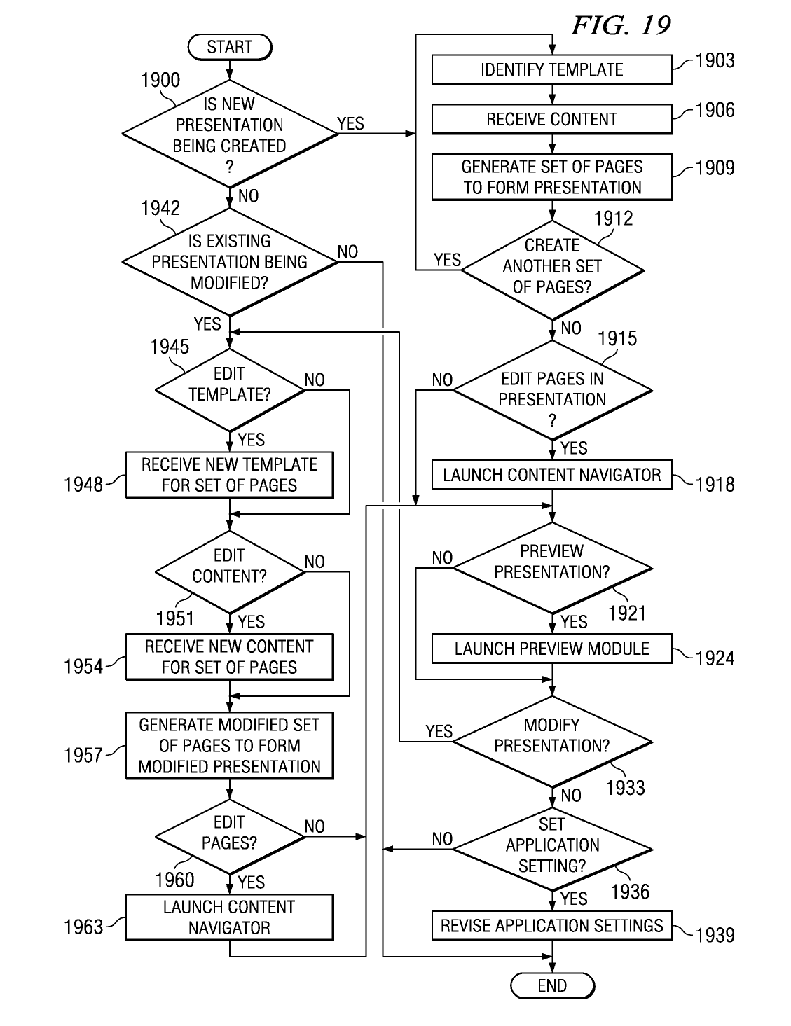

Presentation generation system 305 also includes application settings module 350. Application settings module 350 allows user 315 to indicate settings for presentation generation system 305 and the components contained therein. For example, application settings module 350 may allow user 315 to specify the style of the text editor in page editor 325. Application settings module 350 may also allow user 315 to specify the default size for browser windows that are launched by preview module 345. Application settings module 350 may also allow user 315 to specify the default course template for course creator 310. Application settings module 350 will be discussed in greater detail with respect to FIG. 19 below.

Turning now to FIG. 4, a graphical representation of a course creator in a system for generating an electronic learning presentation in a network-computing environment is depicted in accordance with an illustrative embodiment. Specifically, FIG. 4 includes course creator page 400, which shows an example of the functionality provided by course creator 310 in FIG. 3.

Course creator page 400 includes select template editable field 405. Select template editable field 405 accepts input indicating a course template for an electronic learning presentation. Select template editable field 405 allows a user to select from multiple course template options by clicking on one of radio buttons 410. The course template options included in radio buttons 410 are a web-based training standard template and an independent template.

Course creator page 400 includes directory name editable field 415, which accepts input indicating a directory name for storing a course file associated with an electronic learning presentation. Course creator page 400 also includes number of lessons editable field 420, which accepts input indicating a number of lessons to be included in the course file associated with an electronic learning presentation. Lesson types section 425 allows a user to select the type of module associated with each lesson. Specifically, lesson types section 425 accepts input indicating whether each lesson is a “content module” or “assessment module.”

Turning now to FIG. 5, a graphical representation of a page editor in a system for generating an electronic learning presentation in a network-computing environment is depicted in accordance with an illustrative embodiment. Specifically, FIG. 5 includes page editor page 500, which shows an example of the functionality provided by page editor 325 in FIG. 3.

Page editor page 500 accepts input regarding creating or modifying an electronic learning presentation. Page editor page 500 includes create/edit HTML page section 505. Create/edit HTML page section 505 includes section 510, which contains create new content radio button 512 and modify existing content radio button 514. Create new content radio button 512 is selected by a user to indicate that the user would like to create a new set of pages containing new content. Modify existing content radio button 514 is selected by a user to indicate that the user would like to modify existing content on an existing set of pages.

Create/edit HTML page section 505 includes select template drop down list box 515. Select template drop down list box 515 presents a list of templates to a user, such as list of templates 326 in FIG. 3. The template selected from select template drop down list box 515 is used to form a set of pages in an electronic learning presentation. Select template drop down list box 515 is discussed in further detail with respect to FIG. 6 below.

Create/edit HTML page section 505 includes save location text box 520. Save location text box 520 accepts input indicating a location to save a generated set of pages. In one example, the completed set of pages is saved as a hypertext markup language file. In addition, save file name text box 525 accepts input indicating a file name of the file that includes the completed set of pages. The file having the indicated file name may then be saved in the directory location indicated in save location text box 520.

Create/edit HTML page section 505 also includes create/edit page button 530. Create/edit page button 530, when selected, creates or edits a set of pages according to the settings indicated in section 510, select template drop down list box 515, save location text box 520, and save file name text box 525.

Page editor page 500 includes edit specific course files section 534. Edit specific course files section 534 includes main course directory text box 535. Main course directory text box 535 accepts input indicating a directory name for a course file to be edited. The course file includes the electronic learning presentation. Upon indicating a directory name for a course file to be edited in main course directory text box 535, a user may select edit course title button 540 to change the title of the indicated course file.

Edit specific course files section 534 includes number of lessons text box 545 and generate button 550, which allow a user to specify the number of lessons to be included in a course file. In one embodiment, the course file includes two lessons by default. In addition, course lessons section 560 includes text boxes that accept input indicating the folder names for the lessons included in a course file.

Page editor page 500 also includes application menu 570. Application menu 570 allows a user to navigate to different components of the presentation generation system. Each selectable field in application menu 570 corresponds to a different component of the presentation generation system.

For example, introduction selection 571 may launch an introduction screen that introduces a user to the functions of the presentation generation system. Course creator selection 572 launches a course creator component of presentation generation system, such as course creator 310 in FIG. 3. Page editor selection 573 launches a page editor component of presentation generation system, such as page editor 325 in FIG. 3. Content navigator selection 574 launches a content navigator component of the presentation generation system, such as content navigator 340 in FIG. 3. Preview launcher selection 575 launches a preview launcher component of the presentation generation system, such as preview module 345 in FIG. 3.

Application settings selection 577 launches an application settings component of the presentation generation system, such as application setting module 350 in FIG. 3.

Page editor page 500 also includes help menu 580. Help menu 580 includes selectable fields that facilitate the delivery of help content for the presentation generation system to a user. Help menu 580 includes demo simulations 582, which displays one or more demonstrations of the functionality of the presentation generation system. Help menu 580 also includes user guide 584, which provides a user guide for the presentation generation system to the user.

Page editor page 500 also includes development aids menu 590. The ToolTips selection in development aids menu 590 opens a help file containing instructions for adding a ToolTip to a word or words in the course. For example, when a user hovers or moves the mouse pointer over a word or words in the course that has ToolTip capability, a pop-up dialog box will appear presenting more information about the word or words. The Images selection in development aids menu 590 opens a help file that contains instructions for adding functionality to launch a new browser window that displays an image to the user, and which instructs a developer as to how to insert smaller images into the course content pages. The Styles selection in development aids menu 590 opens a default styles preview palette. For example, the styles preview palette may contain customer-specific text colors and background colors.

Turning now to FIG. 6, a graphical representation of a page editor in a system for generating an electronic learning presentation in a network-computing environment is depicted in accordance with an illustrative embodiment. Specifically, FIG. 6 shows page editor page 600, which is an alternative view of page editor page 500 in FIG. 5.

FIG. 6 includes select template drop down list box 615, which is an example of select template drop down list box 515 in FIG. 5. Select template drop down list box 615 includes list of templates 620, such as list of templates 326 in FIG. 3. Each of the templates shown in select template drop down list box 615 may be used to form a set of pages in an electronic learning presentation.

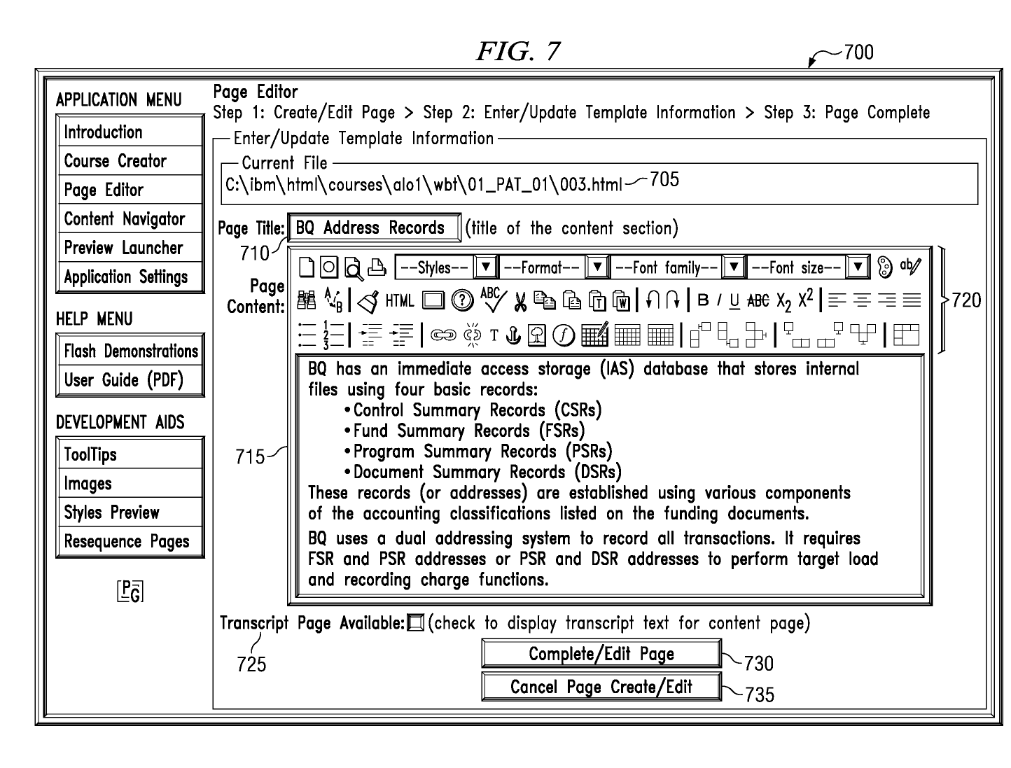

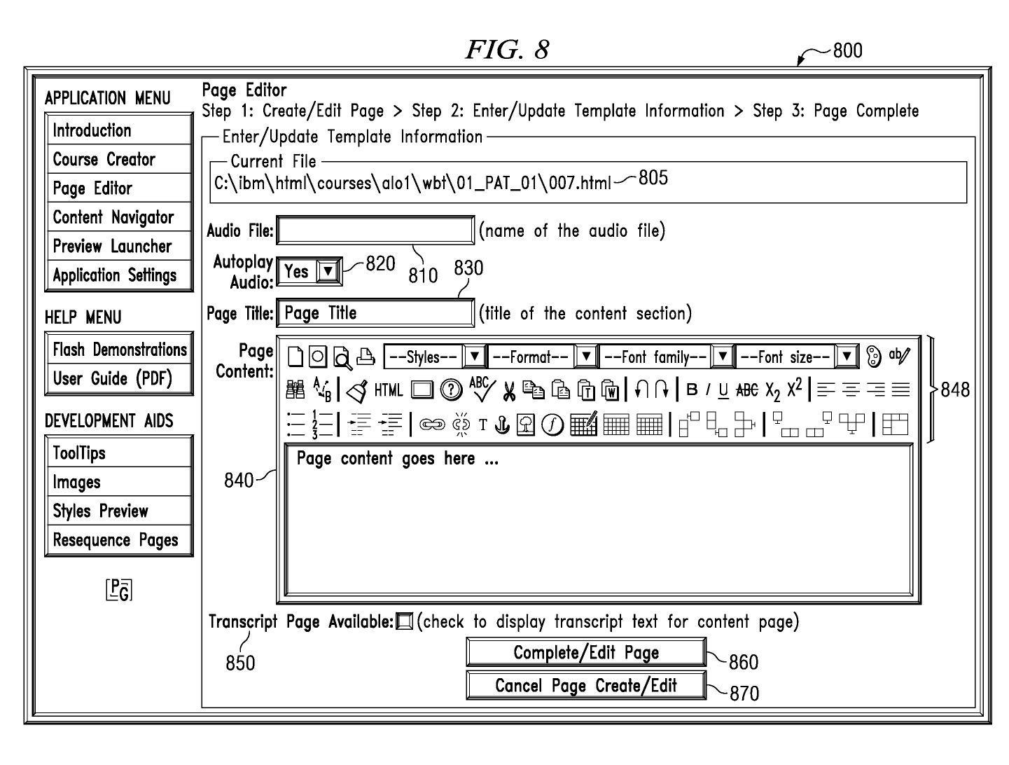

Included in list of templates 620 is content page, page content with audio, assessment, progress check, and pop up page. The content page, page content with audio, assessment, and progress check templates will be discussed in greater with respect to FIGS. 7-10 and 12-15 below. The pop up page template provides the developer with the functionality to create and edit a pop up page that may open during the electronic learning presentation. Other types of templates that may be included in list of templates 620 include a process map template, which provides the developer with the functionality to insert a process map, such as those created by Microsoft® Visio®, which details any process or flow. In another example, a checklist template may be included in list of templates 620. The checklist template provides the developer with a predefined checklist template in order to insert content in a checklist format for standard delivery.

Turning now to FIG. 7, a graphical representation of a content page template in a system for generating an electronic learning presentation in a network-computing environment is depicted in accordance with an illustrative embodiment. Specifically, FIG. 7 shows content page template 700, which is an example of the ‘content page’ selection shown in list of templates 620 in FIG. 6. Content page template 700 may also be one of list of templates 326 in FIG. 3.

Content page template 700 includes current file section 705. Current file section 705 indicates the file location and file name of the set of pages associated with content page template 700.

Content page template 700 also includes page title text box 710 and page content text box 715, both of which are editable fields adapted for receiving educational content, such as educational content 327 and 329 in FIG. 3. Page title text box 710 accepts input indicating a title to be displayed on the completed set of pages formed from content page template 700. Page content text box 715 accepts educational content to be displayed on the completed set of pages formed from content page template 700.

Page content text box 715 includes content controls 720, which allows a user to edit the content in page content text box 715. For example, content controls 720 allow a user to specify the font and style of text in page content text box 715, as well as copy and paste content into and out of page content text box 715.

Content page template 700 also includes transcript page available check box 725. When the transcript page available check box 725 is checked, the presentation engine displays a rich text edit input field that is separate from page content text box 715. The rich text edit input field may contain additional content applicable to the text that is being created or edited in page content text box 715. Also, when the transcript page available check box 725 is checked, a link is provided to the user that displays additional information regarding the current topic.

Complete/edit page button 730 may be selected to save the changes made to content page template 700 at the file and file location indicated in current file section 705. Cancel page create/edit button 735 cancels any changes made to content page template 700 and does not save the changes to the file and file location indicated in current file section 705.

Turning now to FIG. 8, a graphical representation of a content page with audio template in a system for generating an electronic learning presentation in a network-computing environment is depicted in accordance with an illustrative embodiment. Specifically, FIG. 8 shows content page with audio template 800, which is an example of the ‘content page w/audio’ selection shown in list of templates 620 in FIG. 6. Content page with audio template 800 may also be one of list of templates 326 in FIG. 3.

Content page with audio template 800 includes current file section 805. Current file section 805 indicates the file location and file name of the set of pages formed from content page with audio template 800.

Content page with audio template 800 includes audio file text box 810. Audio file text box 810 accepts input indicating an audio file to be played while the set of pages formed from content page with audio template 800 is displayed on a user interface, such as user interface 320 in FIG. 3. Audio file text box 810 may accept audio files having a variety of formats, such as a wave file or mp3 file. Autoplay audio drop down list box 820 allows a user to indicate whether the audio file indicated in audio file text 810 is played automatically upon displaying the set of pages formed from content page with audio template 800.

Content page with audio template 800 also includes page title text box 830 and page content text box 840, both of which are editable fields adapted for receiving educational content, such as educational content 327 and 329 in FIG. 3. Page title text box 830 accepts input indicating a title to be displayed on the set of pages formed from content page with audio template 800. Page content text box 840 accepts educational content to be displayed on the set of pages formed from content page with audio template 800.

Page content text box 840 includes content controls 848, which allows a user to edit the content in page content text box 840. For example, content controls 848 allow a user to specify the font and style of text in page content text box 840, as well as copy and paste content into and out of page content text box 840.

Content page with audio template 800 also includes transcript page available check box 850. When the transcript page available check box 850 is checked, the presentation engine displays a rich text edit input field that is separate from page content text box 840. The rich text edit input field may contain additional content applicable to the text that is being created or edited in page content text box 840. Also, when the transcript page available check box 850 is checked, a link is provided to the user that displays additional information regarding the current topic.

Complete/edit page button 860 may be selected to save the changes made to content page with audio template 800 at the file and file location indicated in current file section 805. Cancel page create/edit button 870 cancels any changes made to content page with audio template 800 and does not save the changes to the file and file location indicated in current file section 805.

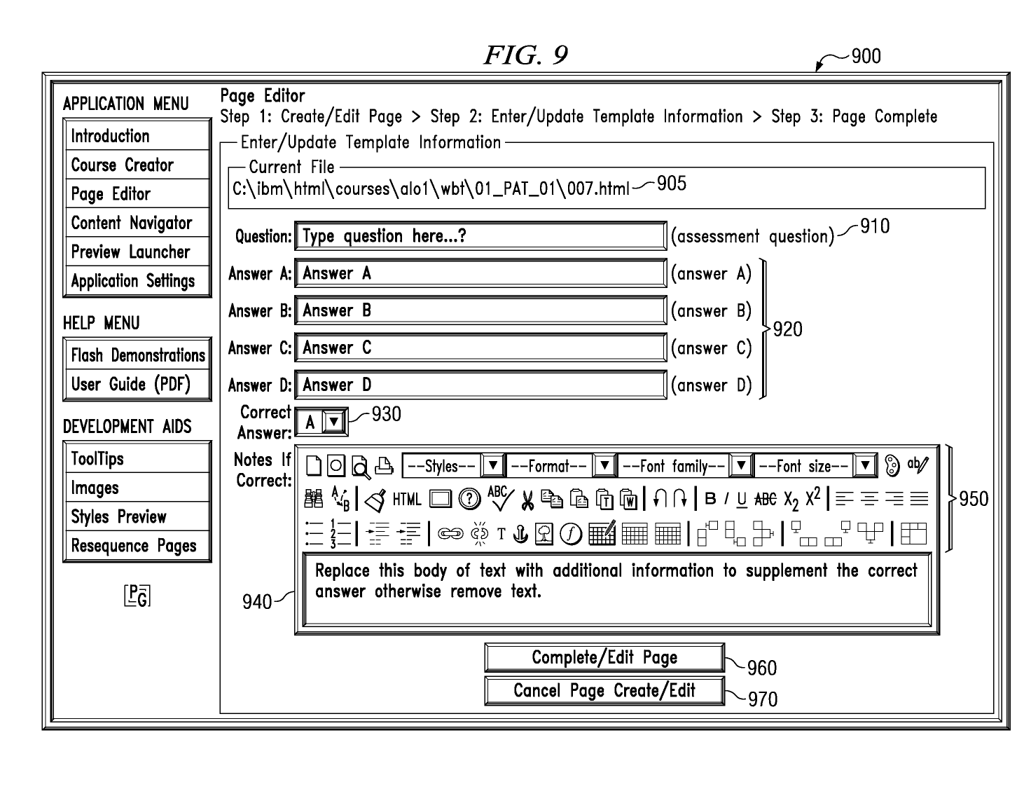

Turning now to FIG. 9, a graphical representation of an assessment question template in a system for generating an electronic learning presentation in a network-computing environment is depicted in accordance with an illustrative embodiment. Specifically, FIG. 9 shows assessment template 900, which is an example of the ‘assessment’ selection shown in list of templates 620 in FIG. 6. Assessment template 900 may also be one of list of templates 326 in FIG. 3.

Assessment template 900 includes current file section 905. Current file section 905 indicates the file location and file name of the set of pages formed from assessment template 900.

Assessment template 900 includes question text box 910. Question text box 910 accepts a question to be presented to a user in the set of pages formed from assessment question template 900.

Assessment template 900 includes a set of selectable fields. The set of selectable fields includes one or more selectable fields. A selectable field is a field in a set of pages in an electronic learning presentation that may be selected by a user. Answer text boxes 920 accept answer choices to be presented to a user in the set of pages formed from assessment question template 900. Although FIG. 9 shows four answer choices in answer text boxes 920, answer text boxes 920 may contain any number of answer choices. Answer text boxes 920 are a set of selectable fields. Correct answer drop down list box 930 allows a user to indicate the correct answer in answer text boxes 920 to the question in question text box 910.

Notes if correct text box 940 accepts education content to be displayed on set of pages formed from assessment template if a user correctly answers the question in question text box 910. Notes if correct text box 940 includes content controls 950, which allows a user to edit the content in notes if correct text box 940. For example, content controls 950 allow a user to specify the font and style of text in notes if correct text box 940, as well as copy and paste content into and out of notes if correct text box 940.

Complete/edit page button 960 may be selected to save the changes made to assessment template 900 at the file and file location indicated in current file section 905. Cancel page create/edit button 970 cancels any changes made to assessment template 900 and does not save the changes to the file and file location indicated in current file section 905.

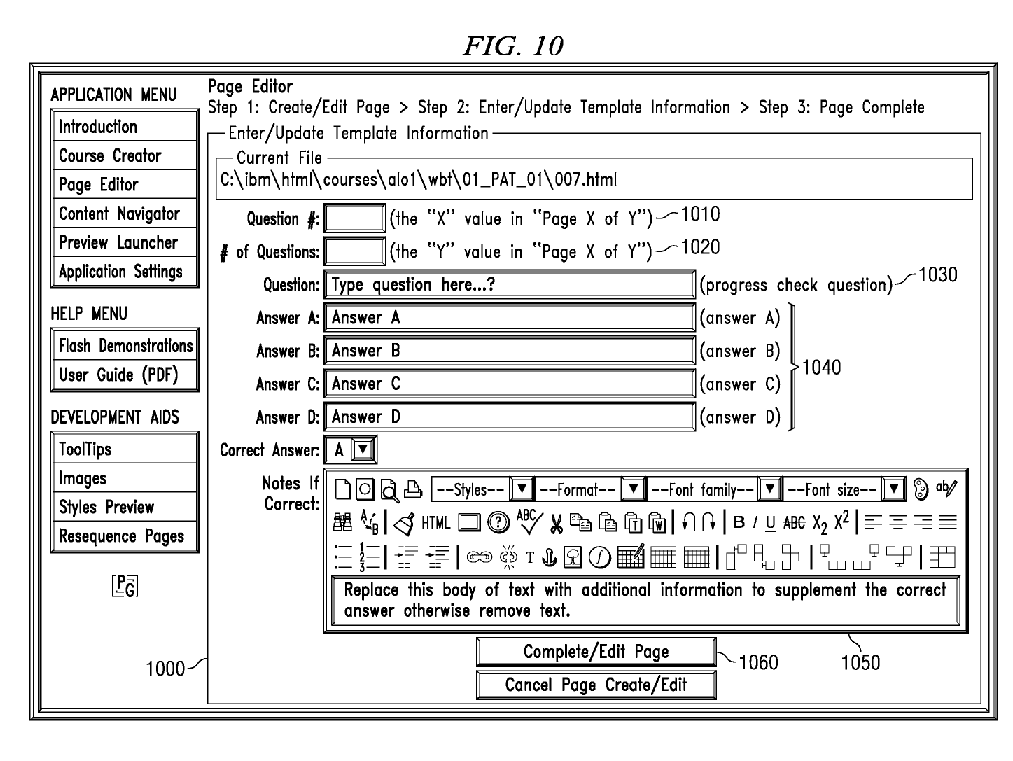

Turning now to FIG. 10, a graphical representation of a progress check template in a system for generating an electronic learning presentation in a network-computing environment is depicted in accordance with an illustrative embodiment. Specifically, FIG. 10 shows progress check template 1000, which is an example of the progress check selection shown in list of templates 620 in FIG. 6. Progress check template 1000 may also be one of list of templates 326 in FIG. 3.

FIG. 10 shows progress check template 1000 to include substantially similar editable fields as assessment template 900 in FIG. 9. However, progress check template 1000 also includes question # text box 1010 and # of questions text box 1020. # of questions text box 1020 accepts input indicating the number of questions to be presented in the set of pages formed from progress check template 1000. Question # text box accepts input indicating the question number associated with the question in question text box 1030.

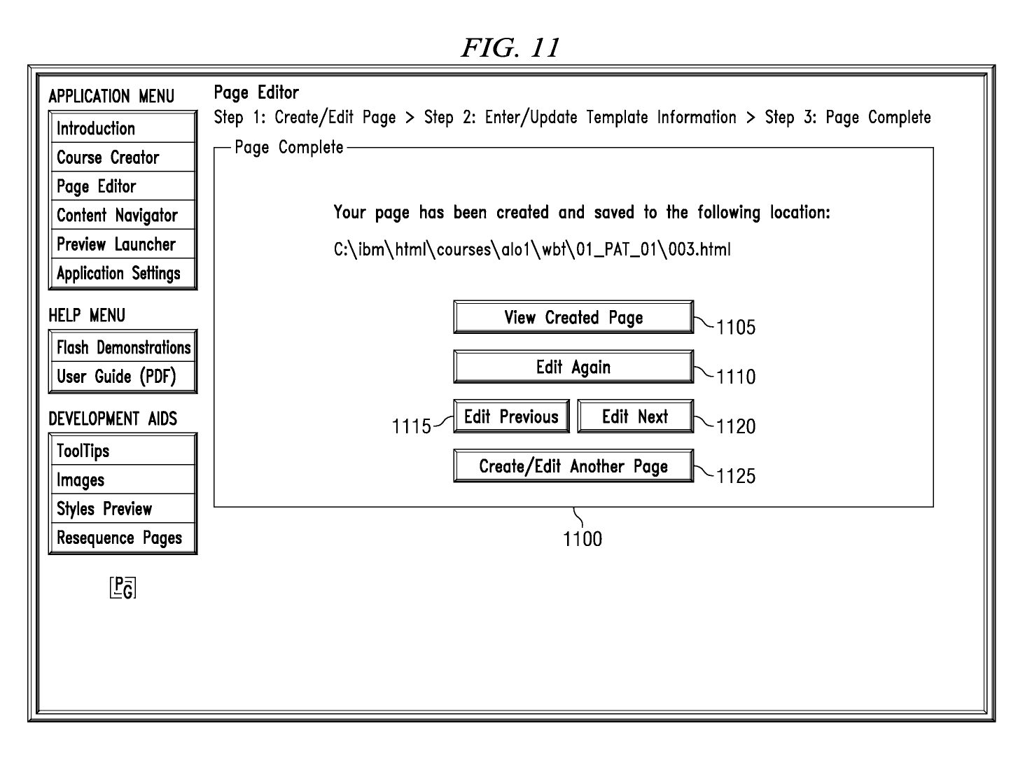

Turning now to FIG. 11, a graphical representation of a page editor in a system for generating an electronic learning presentation in a network-computing environment is depicted in accordance with an illustrative embodiment. Specifically, FIG. 11 shows page editor page 1100, which may be presented after a set of pages are created or edited in the page editor component of the presentation generation system. For example, page editor page 1100 may be presented after any one of complete page/edit page buttons 730, 860, 960, or 1060 in FIGS. 7, 8, 9, and 10, respectively, are selected.

Page editor page 1100 includes view created page button 1105. View created page button 1105 launches a window, such as a browser window, showing a completed set of pages corresponding to a particular template.

Edit again button 1110 returns a user to a template page, such as content page template 700 in FIG. 7, content page with audio template 800 in FIG. 8, assessment template 900 in FIG. 9, or progress check template 1000 in FIG. 10. A user may then further edit the content of the editable fields in the template page.

Edit previous button 1115 allows a user to edit a previous set of pages in the electronic learning presentation. Edit next button 1120 allows a user to edit the next set of pages in the electronic learning presentation. Create/edit another page button 1125 allows a user to create a new set of pages for inclusion in the electronic learning presentation, or to edit an existing set of pages in the electronic learning presentation.

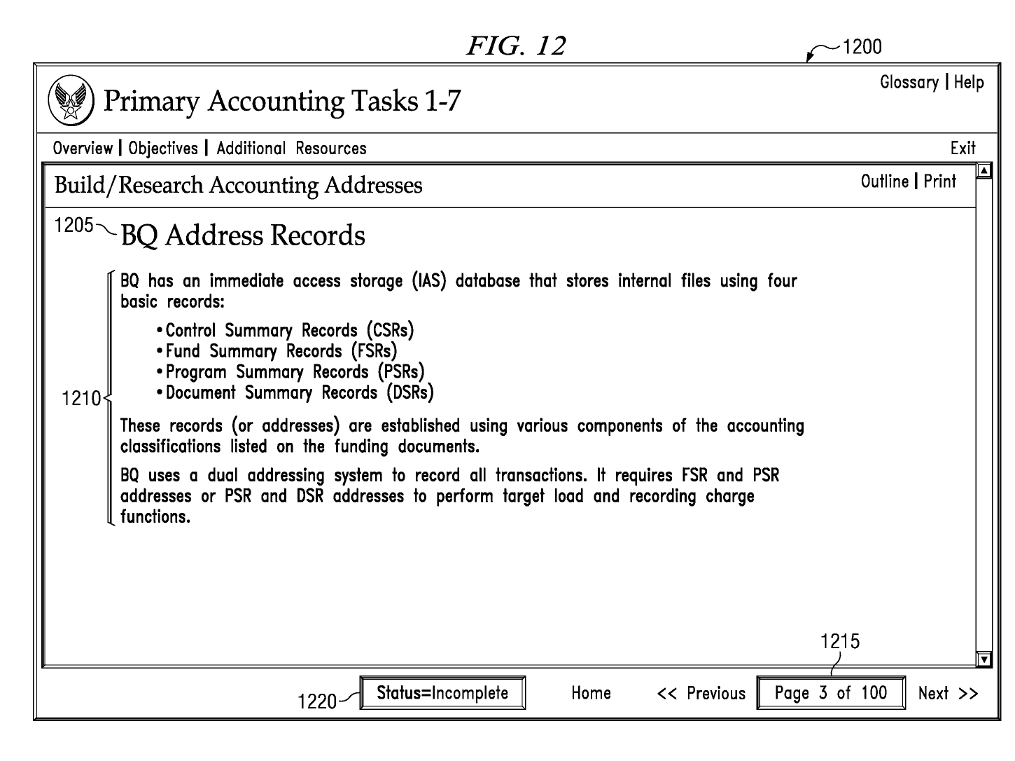

Turning now to FIG. 12, a graphical representation of a content page in an electronic learning presentation in a system for generating an electronic learning presentation in a network-computing environment is depicted in accordance with an illustrative embodiment. Specifically, FIG. 12 shows content page 1200, which is a set of pages containing one page formed from content page template 700 in FIG. 7. In one example, content page 1200 is formed after selecting complete/edit page button 730 in FIG. 7. Content page 1200 may be presented on a user interface, such as user interface 320 in FIG. 3.

Content page 1200 shows page title 1205. Page title 1205 is the same page title indicated in page title text box 710 in FIG. 7. Content page 1200 also shows page content 1210. Page content 1210 is the same educational content indicated in page content text box 715 in FIG. 7.

Content page 1200 also includes page indicator 1215, which indicates the current page that is displayed for an electronic learning presentation. In this example, content page 1200 is page three in an electronic learning presentation having one-hundred pages. Content page 1200 also includes status indicator 1220. Status indicator 1220 indicates whether a user has completed the electronic learning presentation that includes content page 1200.

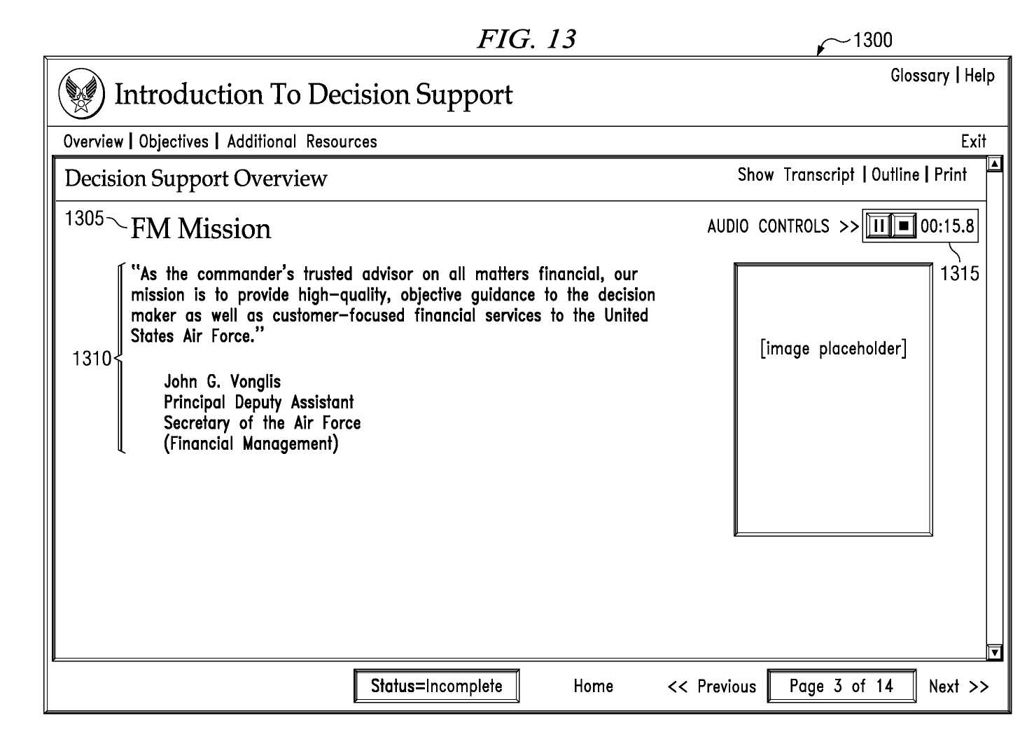

Turning now to FIG. 13, a graphical representation of a content page with audio in an electronic learning presentation in a system for generating an electronic learning presentation in a network-computing environment is depicted in accordance with an illustrative embodiment. Specifically, FIG. 13 shows content page with audio 1300, which is a set of pages containing one page formed from content page with audio template 700 in FIG. 7. In one example, content page 1300 is formed after selecting complete/edit page button 860 in FIG. 8. Content page with audio 1300 may be presented on a user interface, such as user interface 320 in FIG. 3.

Content page with audio 1300 shows page title 1305. Page title 1305 is the page title indicated in page title text box 830 in FIG. 8. Content page with audio 1300 also shows page content 1310. Page content 1310 is the education content indicated in page content text box 840 in FIG. 8. Content page with audio 1300 also shows audio controls 1315. Audio controls 1315 allows a user to control the execution of the audio file indicated in audio file text box 810 in FIG. 8. For example, a user may use audio controls 1315 to play, stop, or pause an audio file.

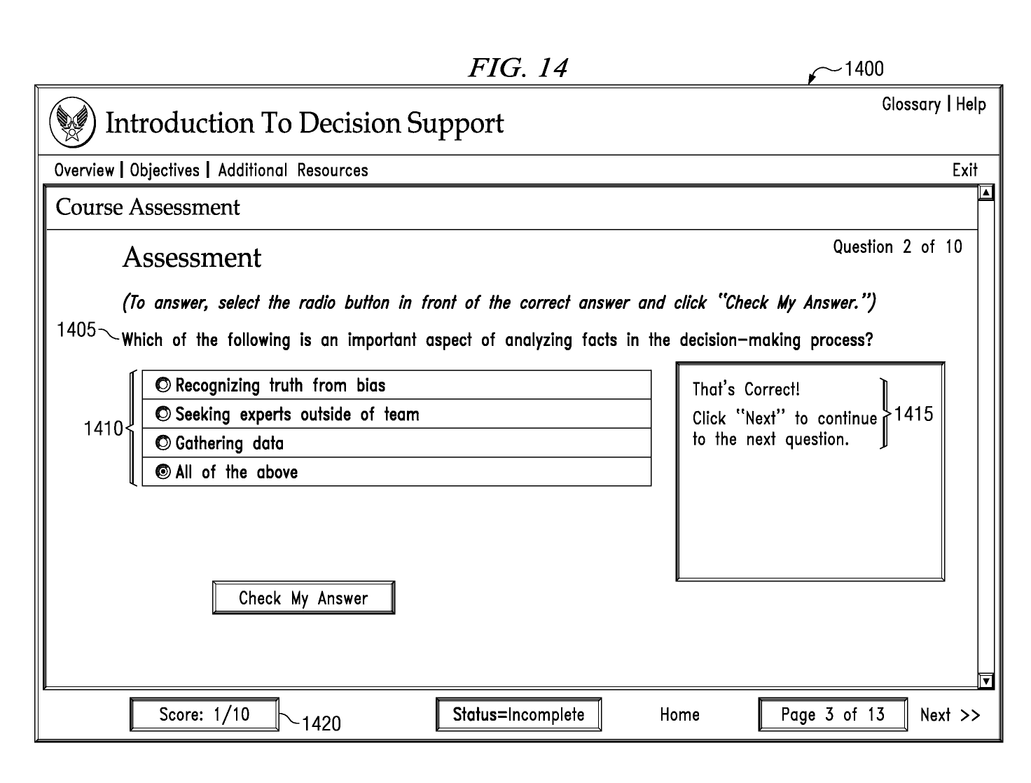

Turning to FIG. 14, a graphical representation of an assessment page in an electronic learning presentation in a system for generating an electronic learning presentation in a network-computing environment is depicted in accordance with an illustrative embodiment. Specifically, FIG. 14 shows assessment page 1400, which is a set of pages containing one page formed from assessment template 900 in FIG. 9. In one example, assessment page 1400 is formed after selecting complete/edit page button 960 in FIG. 9. Assessment page 1400 may be presented on a user interface, such as user interface 320 in FIG. 3.

Assessment page 1400 includes question 1405. Question 1405 is the question indicated in question text box 910 in FIG. 9. Assessment page 1400 also shows answers 1410. Answers 1410 are the answers indicated in answer text boxes 920 in FIG. 9. Also, notes if correct text 1415 is the text indicated in notes if correct text box 940 in FIG. 9. In one example, notes if correct text 1415 displays on assessment page 1400 in response to a user selecting the correct answer in answers 1410.

Assessment page 1400 also includes score indicator 1420. Score indicator 1420 indicates the number of questions that a user has answered correctly as a ratio of the total number of questions included in a particular set of pages.

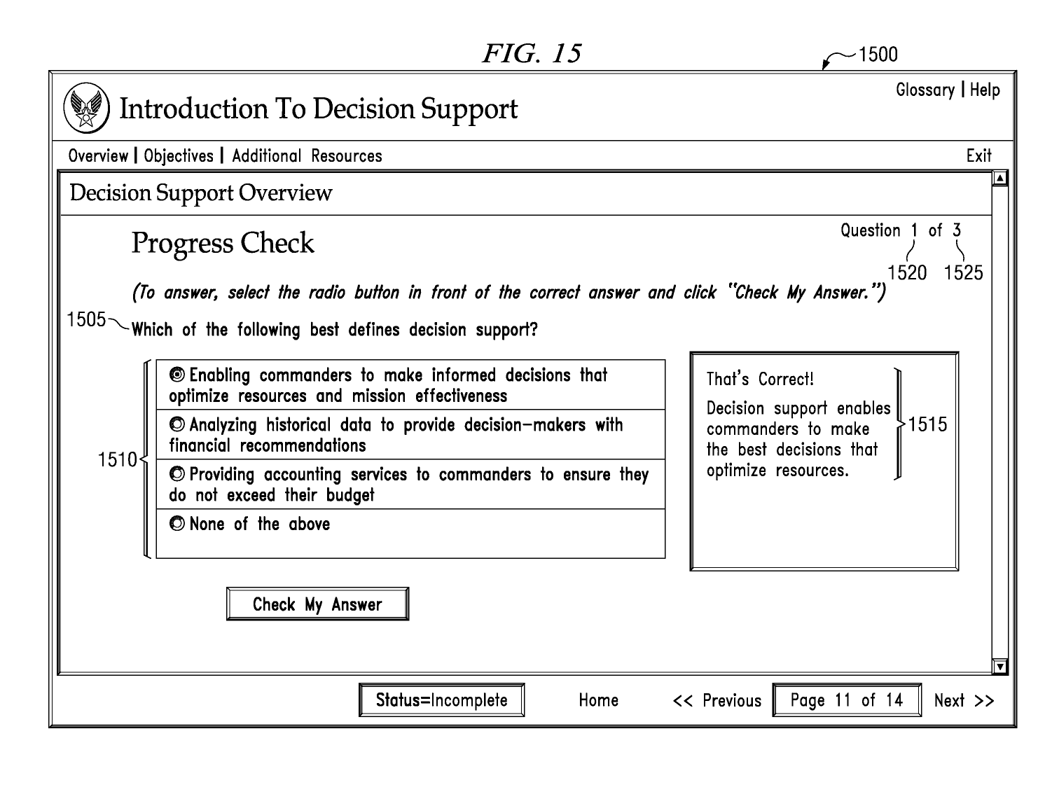

Turning now to FIG. 15, a graphical representation of a progress check page in an electronic learning presentation in a system for generating an electronic learning presentation in a network-computing environment is depicted in accordance with an illustrative embodiment. Specifically, FIG. 15 shows progress check page 1500, which is a set of pages containing one page formed from progress check template 1000 in FIG. 10. In one example, progress check page 1500 is formed after selecting complete/edit page button 1060 in FIG. 10. Progress check page 1500 may be presented on a user interface, such as user interface 320 in FIG. 3.

Progress check page 1500 includes question 1505. Question 1505 is the question indicated in question text box 1030 in FIG. 10. Progress check page 1500 also shows answers 1510. Answers 1510 are the answers indicated in answer text boxes 1040 in FIG. 10. Also, notes if correct text 1515 is the text indicated in notes if correct text box 1050 in FIG. 10. In one example, notes if correct text 1515 displays on progress check page 1500 in response to a user selecting the correct answer in answers 1510.

Question number 1520 indicates a question number for the currently displayed question in progress check page 1500. Question number 1520 is the question number indicated in question # text box 1010 in FIG. 10. Number of questions 1525 indicates the total number of questions included in a particular set of pages, such as the set of pages containing a progress check. Number of questions 1525 is the number of questions indicated in # of questions text box 1020 in FIG. 10.

Turning now to FIG. 16, a graphical representation of a content navigator in a system for generating an electronic learning presentation in a network-computing environment is depicted in accordance with an illustrative embodiment. Specifically, FIG. 16 shows content navigator page 1600, which shows an example of the functionality provided by content navigator 340 in FIG. 3.

Content navigator page 1600 includes select ‘course.js.’ file text box 1605. Select ‘course.js.’ file text box 1605 accepts input indicating a course file to be edited by the content navigator of the presentation generation system. Although select ‘course.js.’ file text box 1605 indicates that only a course file having a .js extension should be entered, the course file inputted into select ‘course.js.’ file text box 1605 may also be any course file, regardless of the course file's extension. Submit button 1610 launches the content navigator such that the set of pages in the course file indicated in select ‘course.js.’ file text box 1605 may be edited.

Turning now to FIG. 17, a graphical representation of a preview launcher in a system for generating an electronic learning presentation in a network-computing environment is depicted in accordance with an illustrative embodiment. Specifically, FIG. 17 shows preview launcher page 1700, which shows an example of the functionality provided by preview module 345 in FIG. 3.

Preview launcher page 1700 includes text box 1710. Text box 1710 accepts input indicating a file name or directory path of a course file, set of pages, or electronic learning presentation to preview. Open preview button 1715 may be selected to open a window in which the course file, set of pages, or electronic learning presentation indicated in text box 1710.

Preview launcher page 1700 includes window size section 1720. Window size section 1720 accepts input indicating a window size in which to launch a preview of the course file, set of pages, or electronic learning presentation indicated in text box 1710. The window size may be indicated using a variety of measurement units, such as centimeters, inches, or pixels.

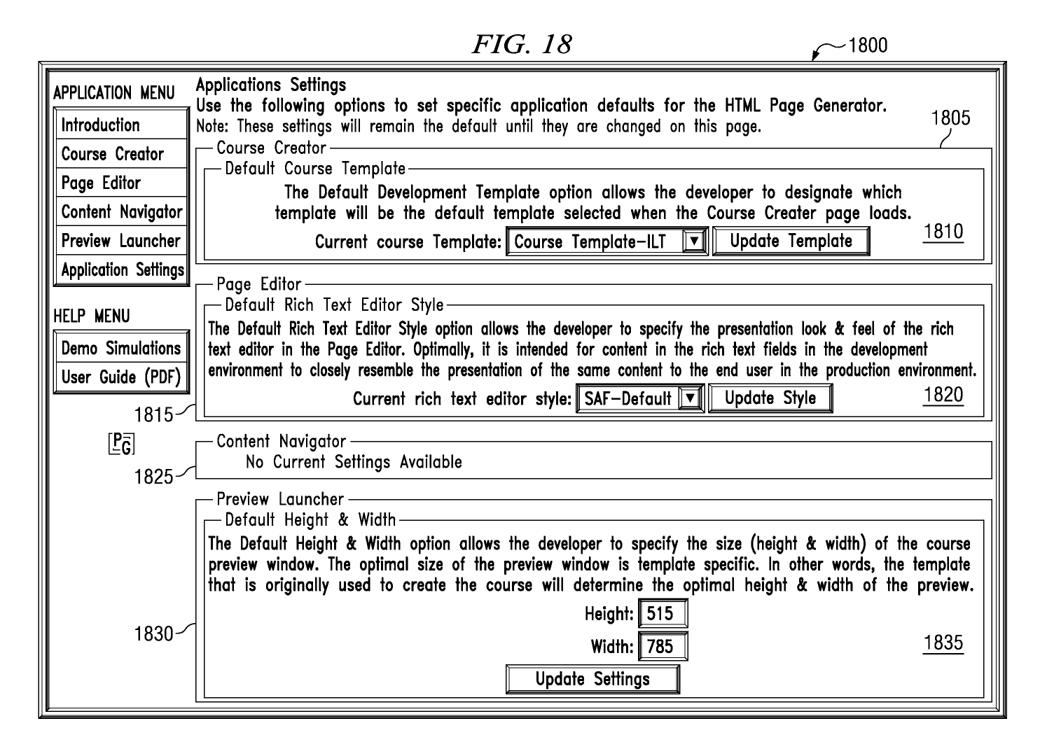

Turning now to FIG. 18, a graphical representation of an application settings module in a system for generating an electronic learning presentation in a network-computing environment is depicted in accordance with an illustrative embodiment. Specifically, FIG. 18 shows application settings page 1800, which shows an example of the functionality provided by application settings module 350 in FIG. 3.

Application settings page 1800 includes course creator section 1805. Course creator section 1805 allows a user to select settings for a course creator in presentation generation system, such as course creator 310 in FIG. 3. Course creator section 1805 includes default course template section 1810, which accepts input indicating a default course template. The selectable default course templates in default course template section 1810 may include the course templates represented by radio buttons 410 in FIG. 4.

Application settings page 1800 includes page editor section 1815. Page editor section 1815 allows a user to select settings for a page editor in the presentation generation system, such as page editor 325 in FIG. 3. Page editor section 1815 includes default rich text editor style section 1820. Default rich text editor style section 1820 accepts input indicating a format of the content text boxes in the page editor.

Application settings page 1800 includes content navigator section 1825. Content navigator section 1825 allows a user to select settings for a content navigator in the presentation generation system, such as content navigator 340 in FIG. 3.

Application settings page 1800 also includes preview launcher section 1830. Preview launcher section 1830 allows a user to select settings for a preview launcher in the presentation generation system, such as preview module 345 in FIG. 3. Preview launcher section 1830 includes default height and width section 1835, which accepts input indicating a height and width of a window to preview a course file, set of pages, or electronic learning presentation indicated. The settings indicated in default height and width section 1835 are used if no settings are indicated in window size section 1720 in FIG. 17.

Turning now to FIG. 19, a flowchart illustrating a process for generating an electronic learning presentation in a network-computing environment is depicted in accordance with an illustrative embodiment. The process illustrated in FIG. 19 may be implemented by a presentation generation system, such as presentation generation system 305 in FIG. 3.

The process begins by determining whether a new set of pages in an electronic learning presentation is being created (step 1900). If the process determines that a new set of pages in an electronic learning presentation is being created, the process identifies a template in a list of templates (step 1903). In one example, the process identifies the template in the list of templates by receiving a selection of the template from a user. The process receives educational content into the identified template (step 1906).

The process generates a set of pages using the identified template to form the electronic learning presentation (step 1909). The set of pages includes the educational content. The process determines whether to create another set of pages (step 1912). If the process determines to create another set of pages, the process returns to step 1903.

Returning to step 1912, if the process determines not to create another set of pages, the process determines whether pages in the set of pages should be added, deleted, or placed in a particular order (step 1915). If the process determines that pages in the set of pages should be added, deleted, or placed in a particular order, the process launches the content navigator (step 1918). The process then proceeds to step 1921.

Returning to step 1915, if the process determines that pages in the set of pages should not be added, deleted, or placed in a particular order, the process determines whether to preview a set of pages in the electronic learning presentation (step 1921). If the process determines to preview a set of pages in the electronic learning presentation, the process launches the preview module to provide the preview (step 1924). The process then proceeds to step 1933.

Returning to step 1921, if the process determines not to preview a set of pages in the electronic learning presentation, the process determines whether to modify a set of pages in the electronic learning presentation (step 1933). If the process determines to modify a set of pages in the electronic learning presentation, the process proceeds to step 1945.

Returning to step 1933, if the process determines not to modify a set of pages in the electronic learning presentation, the process determines whether to set or edit application settings (step 1936). If the process determines to set or edit application settings, the process launches application settings module, such as application settings module 350 in FIG. 3, so that application settings can be revised (step 1939). The process then terminates. Returning to step 1936, if the process determines not to set or edit application settings, the process terminates.

Returning to step 1900, if the process determines that a new set of pages in an electronic learning presentation is not being created, the process determines whether an existing set of pages in an electronic learning presentation is being modified (step 1942). If the process determines that an existing set of pages in an electronic learning presentation is not being modified, the process terminates.

Returning to step 1942, if the process determines that an existing set of pages in an electronic learning presentation is being modified, the process determines whether to edit the template of a set of pages in the electronic learning presentation (step 1945). If the process determines to edit the template of a set of pages in the electronic learning presentation, the process receives a new template for the set of pages (step 1948). The process then proceeds to step 1951.

Returning to step 1945, if the process determines not to edit the template of a set of pages in the electronic learning presentation, the process determines whether to edit the educational content of a set of pages in the electronic learning presentation (step 1951). If the process determines to edit the educational content of a set of pages in the electronic learning presentation, the process receives new educational content for the set of pages (step 1954). The process then proceeds to step 1957.

Returning to step 1951, if the process determines not to edit the educational content of a set of pages in the electronic learning presentation, the process generates the set of pages to form a modified electronic learning presentation (step 1957). The process then determines whether pages in the set of pages in the modified electronic learning presentation should be added, deleted, or placed in a particular order (step 1960). If the process determines that pages in the set of pages in the modified electronic learning presentation should be added, deleted, or placed in a particular order, the process launches the content navigator (step 1963). The process then proceeds to step 1921. Returning to step 1960, if the process determines that pages in the set of pages in the modified electronic learning presentation should not be added, deleted, or placed in a particular order, then the process proceeds to step 1921.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer-implemented method, apparatus, and computer program product for generating an electronic learning presentation in a network-computing environment. In one embodiment, the process presents a list of templates. Each template in the list of templates includes a set of editable fields adapted for receiving educational content. Educational content is content that is adapted for teaching a particular subject matter.

The process receives a selection of at least one template in the list of templates. The process also receives the educational content into the at least one template. The process generates a set of pages using the at least one template to form the electronic learning presentation. The set of pages includes the educational content, and includes one or more pages. In one example, the set of pages is a set of hypertext markup language pages.

The electronic learning presentation may also be adapted to be included in a learning management system. A learning management system is a software package that enables the management and delivery of online content to users.

In one embodiment, the process sequences the set of pages into an order in response to input indicating the order. In this embodiment, the input may be from a user or another application. In another embodiment, the process providing a preview of the electronic learning presentation to a user interface.

In another embodiment, the process provides a capability for an outside application to modify the electronic learning presentation such that the electronic learning presentation is compatible with a learning management system. In this example, the learning management system may be compatible with Sharable Content Object Reference Model standards. Also, the outside application may be any computer application capable of modifying an electronic learning presentation to be compatible with a learning management system that is compatible with Sharable Content Object Reference Model standards.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for generating an electronic learning presentation, comprising:
presenting a list of templates, wherein each template in the list of templates includes a set of editable fields adapted for receiving educational content, and wherein the educational content is adapted for teaching a particular subject matter;
receiving a selection of at least one template in the list of templates;
placing the educational content into the at least one template; and
generating a set of pages using the at least one template to form the electronic learning presentation, wherein the set of pages includes the educational content.

2. The computer-implemented method of claim 1, wherein the electronic learning presentation is adapted to be included in a learning management system.

3. The computer-implemented method of claim 1, further comprising:
sequencing the set of pages into an order in response to input indicating the order.

4. The computer-implemented method of claim 1, further comprising:
providing a preview of the electronic learning presentation to a user interface.

5. The computer-implemented method of claim 1, wherein the list of templates includes an audio template, wherein the audio template receives an audio file to be included in the electronic learning presentation.

6. The computer-implemented method of claim 1, wherein the list of templates includes an assessment template, wherein the assessment template receives content to be included in a set of selectable fields, wherein the selectable fields are included in the electronic learning presentation.

7. The computer-implemented method of claim 1, wherein the electronic learning presentation is generated according to sharable content object reference model standards.

8. The computer-implemented method of claim 1, further comprising:
providing a capability for an outside application to modify the electronic learning presentation such that the electronic learning presentation is compatible with a learning management system.

9. The computer-implemented method of claim 1, further comprising:
dynamically modifying the electronic learning presentation in real-time based on additional input from a set of users.

10. The computer-implemented method of claim 1, wherein the electronic learning presentation is generated in an online mode.

11. The computer-implemented method of claim 1, wherein the electronic learning presentation is generated in an off line mode.

12. The computer-implemented method of claim 1, further comprising:
generating a second set of pages using a different template in the list of templates, wherein the second set of pages is included in the electronic learning presentation.

13. A computer program product comprising:
a computer usable medium having computer usable program code for generating an electronic learning presentation, the computer program product comprising:
computer-usable program code for presenting a list of templates, wherein each template in the list of templates includes a set of editable fields adapted for receiving educational content in a particular subject matter;
computer-usable program code for receiving a selection of at least one template in the list of templates;
computer-usable program code for receiving the educational content into the at least one template; and
computer-usable program code for generating a set of pages using the at least one template to form the electronic learning presentation, wherein the set of pages includes the educational content.

14. The computer program product of claim 13, wherein the electronic learning presentation is adapted to be included in a learning management system.

15. The computer program product of claim 13, further comprising:
computer-usable program code for dynamically modifying the electronic learning presentation in real-time based on additional input from a set of users.

16. The computer program product of claim 13, further comprising:
computer-usable program code for providing a capability for an outside application to modify the electronic learning presentation such that the electronic learning presentation is compatible with a learning management system.

17. A system for generating a presentation, comprising:
a page editor, wherein the page editor presents a list of templates on a user interfaces receives a selection of at least one template in the list of templates, and receives educational content into the at least one templates wherein each template in the list of templates includes a set of editable fields adapted for receiving educational content in a particular subject matter; and
a presentation engine, wherein the presentation engine generates a set of pages using the at least one template to form the electronic learning presentation, wherein the set of pages includes the educational content.

18. The system of claim 17, further comprising:
a content navigator, wherein the content navigator sequences the set of pages into an order in response to input indicating the order.

19. The system of claim 17, further comprising:
a preview module, wherein the preview module provides a preview of the electronic learning presentation.

20. The system of claim 17, wherein the electronic learning presentation is adapted to be included in a learning management system.
